(19) United States
(12) Patent Application Publication
(10) Pub. No.: US 2003/0179998 A1
(43) Pub. Date: Sep. 25, 2003

(54) Switchable bragg grating filter

(76) Inventors: Jianjun Zhang, Cupertino, CA (US); Peiching Ling, San Jose, CA (US); Jinliang Chen, Saratoga, CA (US); Ming Xu, San Jose, CA (US)

Correspondence Address: PERKINS COIE LLP, PATENT-SEA, P.O. BOX 1247, SEATTLE, WA, 98111-1247, US

(21) Appl. No.: 10/104,273

(22) Filed: Mar. 22, 2002

(51) Int. Cl. G02B 6/34; G02B 6/26

(52) U.S. Cl. 385/37; 385/50; 385/25

(57) ABSTRACT

A wavelength-selective optical filter is described. The filter includes an input waveguide for carrying a multiplexed optical signal that includes a plurality of wavelength channels. Further, an output waveguide is placed to the input waveguide, the output waveguide having a Bragg grating filter formed thereon. The input waveguide and the output waveguide is separated by a gap distance when said filter is in an off state. Finally, means for displacing the Bragg grating filter sufficiently towards the input waveguide when the filter is in an on state such that the Bragg grating filter can selectively extract one of the plurality of wavelength channels.

### TECHNICAL FIELD OF THE INVENTION

This invention relates generally to Bragg grating-based filters, in particular, switchable Bragg grating-based filters.

### BACKGROUND OF THE INVENTION

Due to the extremely wide transmission bandwidth provided by optical fiber, all-optical fiber networks are increasingly being used as backbones for global communication systems. To fully exploit the fiber bandwidth in such networks, wavelength-division multiplexing (WDM) and wavelength-division demultiplexing (WDD) technologies are employed so that an individual optical fiber can transmit several independent optical streams simultaneously, with the streams being distinguished by their center wavelengths. Since these optical streams are coupled and decoupled based on wavelength, wavelength selective devices are essential components in WDM communication networks. In the past, wavelength selective devices performed the adding, dropping and cross-connecting of individual wavelengths by first converting the optical signal into the electrical domain. However, the development of all-optical WDM communication systems has necessitated the need for all-optical wavelength selective devices. It is desirable for such devices to exhibit the properties of low insertion loss, insensitivity to polarization, good spectral selectivity, and ease of manufacturing.

In today's all-optical Dense WDM (DWDM) networks, three prevailing types of wavelength selecting technology are used: (1) Thin Film Filter (TFF), (2) Arrayed Waveguide (AWG), and (3) Fiber Bragg Grating (FBG). Currently, TFF technology is the predominant choice when the spacing requirements of the wavelength selective device are greater than 100 GHz. The advantages of TFF-based devices are that they are relatively insensitive to temperature, have minimal cross talk, and provide good isolation between different wavelengths. However, devices built using current TFF technology have the following disadvantages: they are difficult to manufacture when the spacing requirement is below 200 GHz; the packaging cost is very high; and the yield is low. Due to these disadvantages, when the spacing requirements are 100 GHz and below, AWG and FBG wavelength selecting devices dominate the market. The advantages of AWG devices are they can support high channel counts, are easy to manufacture, and have a small silicon footprint. Meanwhile, the disadvantages are that AWG devices are prone to cross talk and their packaging is complex. FBG, the second dominant technology when the spacing requirements are 100 GHz and below, have the advantages of short development time, low capital investment, and low packaging cost. However, the FBG products available in the current market have relatively high power loss. Moreover, each channel requires a circulator, which increases component costs and possibly increases packaging costs.

Another technology for wavelength selection is a Bragg grating-based filter (throughout the remainder of this specification, the term “Bragg filters” will be used to refer to this wavelength selection technology of Bragg grating-based filters). Bragg filters are an attractive choice for wavelength selecting functions in many optical network applications. See Murphy et al. “Design of Integrated Bragg Grating-Based Filters for Optical Communications,” NanoStructures Laboratory MIT web site: nanoweb.mit.edu/annual report01/14 (describing lithographic techniques to meet the needs of integrated Bragg gratings used to build a resonator-based add/drop filter and Mach-Zehnder interferometer). Further, U.S. Pat. No. 5,875,272 describes a wavelength-selective optical device for use in a number of WDM and WDD applications. In the '272 patent, a Bragg-grating filter is used to add/drop optical signal of a selected wavelength λₐ to/from a multi-wavelength optical signal. Similarly, in U.S. Pat. No. 5,915,051, a wavelength-selective optical device that uses an interferometric switch is described. This invention's operation mode is similar to that in the '272 patent, where Bragg-grating filters are used to add/drop optical transmissions of a selected wavelength λₐ. However, this device utilizes an interferometric switch to control the state of the device so that wavelength-λₐ transmissions can be selectively added/dropped. The filter is designed to so that the wavelength-λₐ transmissions can either be recombined with the multi-wavelength input from which it was extracted or redirected to a distinct output port.

### BRIEF DESCRIPTIONS OF THE DRAWINGS

The present invention can be better understood with reference to the following drawings. The components within the drawings are not necessarily to scale relative to each other, emphasis instead being placed upon clearly illustrating the principles of the present invention.

FIG. 1A is a schematic view of a switchable Bragg filter in accordance with the present invention used to implement a channel-dropping filter (CDF) in the “off” position;

FIG. 1B is the CDF of FIG. 1a in the “on” position;

FIG. 2A is a schematic view of a switchable Bragg filter in accordance with the present invention used to implement a channel-adding filter (CAF) in the “off” position;

FIG. 2B is the CAF of FIG. 2a in the “on” position;

FIGS. 3A and 3B are cross sectional views of a wavelength-selective grating filter implemented with movable Bragg gratings that couple and de-couple from a waveguide for producing a switchable grating optical filter;

FIGS. 4A to 4O are cross sectional views and top views of different structural configurations of the wavelength selective grating filter in accordance with the present invention for flexible switching on and off of the grating filter; and

FIG. 5 is an alternative embodiment of a Bragg filter in accordance with the present invention.

### DETAILED DESCRIPTION OF THE ILLUSTRATED Embodiments

In the following description, numerous specific details are provided, such as the identification of various system components, to provide a thorough understanding of embodiments of the invention. One skilled in the art will recognize, however, that the invention can be practiced without one or more of the specific details, or with other methods, components, materials, etc. In still other instances, well-known structures, materials, or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The switchable Bragg grating-based filter device of this invention enables a given channel, optical transmissions of a given wavelength λᵢ, to be selectively redirected from one waveguide to another. In one embodiment, the device consists of an input waveguide and two Bragg-grating filters placed alongside the input waveguide in such a way as to work in concert to selectively remove a channel from the input waveguide. As will be seen in greater detail below, the wavelength λᵢ that the filter selectively redirects is determined by the properties of the Bragg-grating filter. Unlike the prior art, the present invention teaches the capability of having channels selectively filtered.

In one embodiment, the filtering action is based on the proximity of the Bragg filters to the input waveguide. In one embodiment, the proximity of the Bragg filters to the input waveguide is controlled by placing electrodes on the input and output waveguides and connecting a source of electrical potential between the electrodes. When a voltage is applied between the two electrodes, the output waveguide electrostatically deflects towards the input waveguide, thereby moving the Bragg filters closer to the input waveguide. The close proximity of the Bragg filters to the input waveguide causes optical transmissions of wavelength λᵢ to be redirected from the input waveguide to the output waveguide via the Bragg filters.

When this occurs, the device is said to be in a filtering state (or ON). When there is no voltage between the two electrodes, the output waveguide returns to its original undeflected state. In this state, the Bragg filters are far enough from the input waveguide so as to not interfere with optical transmissions passing through it. Thus, in a transmitting state (or OFF), the device allows optical transmissions of all wavelengths, including λᵢ, to continue along the input waveguide unhindered.

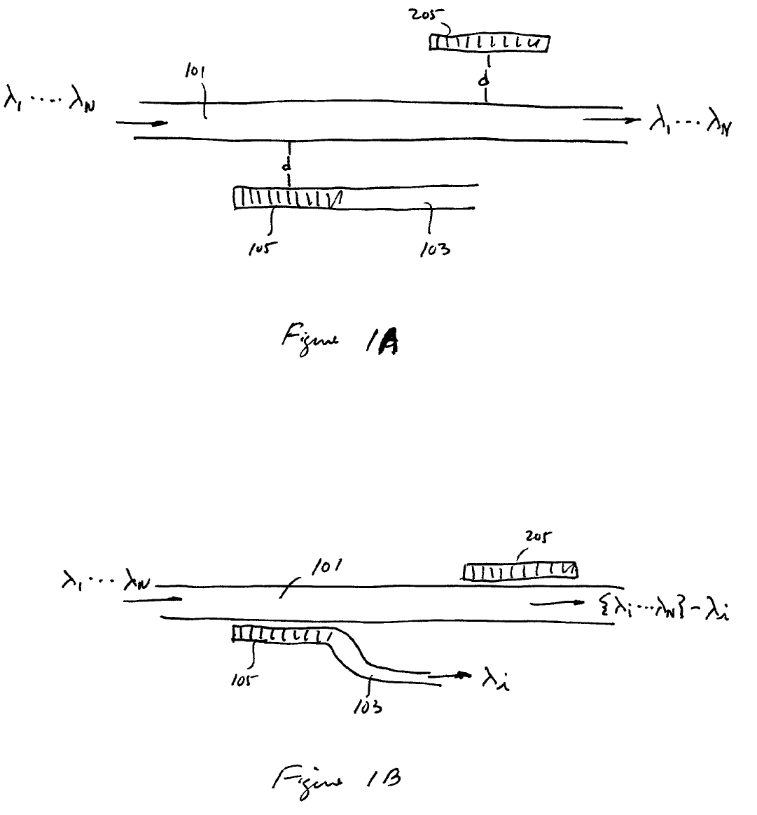

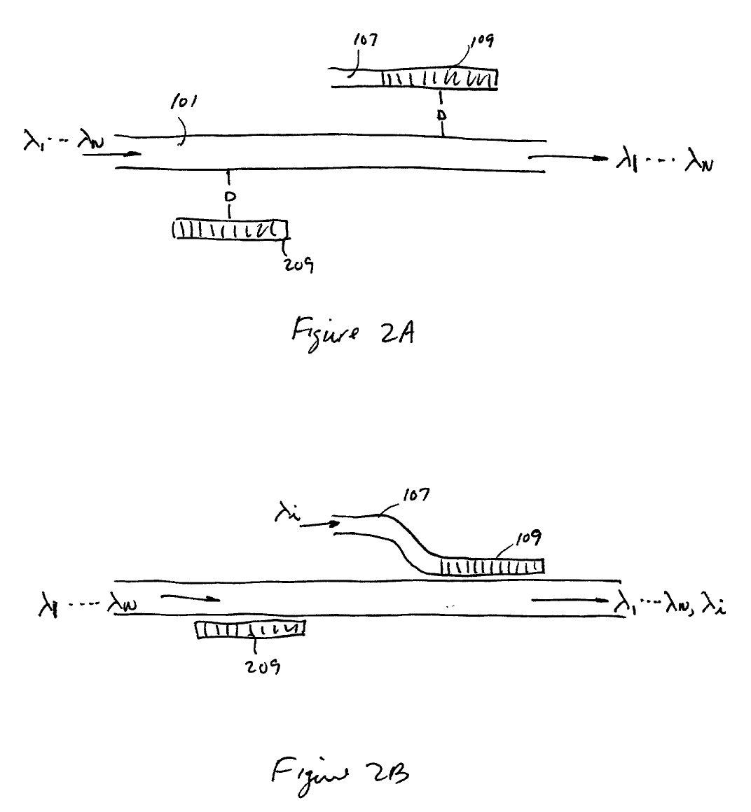

FIGS. 1a and 1b show the operational details of a switchable Bragg filter as described in this invention used in a channel-dropping filter (CDF) device. The CDF shown here enables optical transmissions of wavelength λᵢ to be filtered from the input waveguide 101 using two side-coupled quarter-wave shifted Bragg filters 105 and 205 that act in concert to remove from the input waveguide 101 that channel for which the resonators were designed to evanescently couple from the input waveguide 101. The first Bragg grating along the optical path is a receiver Bragg grating 105 while the second Bragg grating is a reflector Bragg grating 205 (also referred to as a residual filter). Each is formed as a waveguide that is provided with a grating structure having an identical grating period, that period being one which corresponds to the Bragg wavelength, set as λᵢ. The input waveguide carries a multiple-channel optical signal that includes multiple separate wavelengths represented as λ1, λ2, λ3, through λn. A specific wavelength λᵢ (one of the multiple separate wavelengths λn) can then be selectively removed from input waveguide 101 and transferred into output waveguide 103 when the Bragg filters 105 and 205 are disposed proximal to the input waveguide 101.

In the configuration shown in FIG. 1a, the Bragg filters 105 and 205 are separated from the input waveguide 101 by the spacing “d.” The lack of proximity between the filters 105 and 205 and the input waveguide 101 makes it so that the device does not selectively extract the λᵢ wavelength from the input waveguide 101. In the configuration shown in FIG. 1b, however, when the spacing d is diminished, the Bragg filters 105 and 205 couple to and extract the λᵢ wavelength from the input waveguide 101. Here, the reflector Bragg filter 205 resonates in response to the λᵢ channel in input waveguide 101 and evanescently couples to the input waveguide 101 to reflect the λᵢ channel back to the waveguide input (to the left), while allowing the other channels to transmit (to the right) along the waveguide 101 unhindered. Simultaneously, the receiver Bragg filter 105 resonates in response to the λᵢ channel and allows that channel to escape along output waveguide 103. Thus, the two filters 105 and 205, when in close proximity to input waveguide 101, act to remove λᵢ transmissions from the input waveguide 101 and transmit the λᵢ transmissions on output waveguide 103. The Bragg filters 105 and 205 can be activated to the “on” position by closing the spacing d. The method by which the spacing d is closed can be one or more of various methods, including electrostatic attraction commonly used in MEMS devices. When the spacing d exists between the input waveguide 101 and the Bragg filter 105, the Bragg filters 105 and 205 are in the “off position”.

FIGS. 2a and 2b show the operational details of a switchable Bragg filter as described in this invention used in a channel-adding filter (CAF) device. The operation of the CAF device is complementary to that of the CDF. The CAF enables optical transmissions of wavelength λᵢ to be added from the waveguide 107 to the waveguide 101 using two side-coupled quarter-wave shifted Bragg filters 109 and 209. The first Bragg grating along the optical path is a reflector Bragg grating 205 like the one in the CDF device while the second Bragg grating is a transmitter Bragg grating 109. Like in the CDF device, each filter is formed as a waveguide that is provided with a grating structure having an identical grating period, that period being one which corresponds to the Bragg wavelength, set as λᵢ. The input waveguide carries a multiple-channel optical signal. A specific wavelength λᵢ can then be selectively added to waveguide 101 when the Bragg filters 109 and 209 are disposed proximal to the waveguide 101.

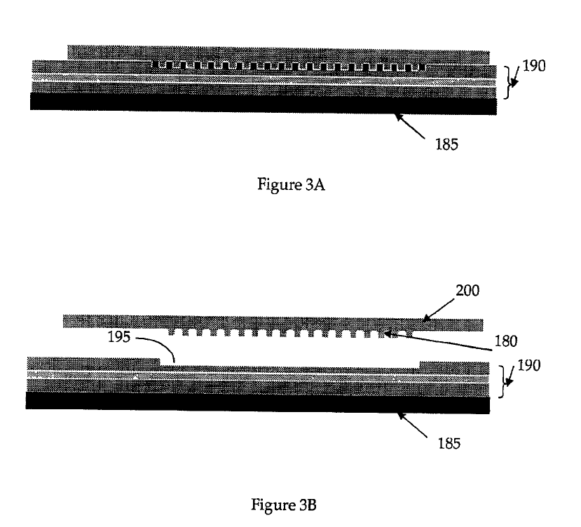

FIGS. 3A and 3B show an embodiment of a switchable Bragg grating filter 130 and are useful for describing the operational principle thereof In FIGS. 3A and 3B, a set of Bragg gratings 180 is moveable to couple to a waveguide 190 formed on a substrate 185 thus activating a filtering function. In FIG. 3A the grating 180 is coupled to the waveguide 190, while in FIG. 3B, the Bragg grating 180 is moved away from the waveguide 190.

Thus, in FIG. 3B, an optical signal propagating in the waveguide 190 will pass through the waveguide without experiencing a filtering operation. However, in FIG. 3A, an optical signal propagating in the waveguide 190 will be reflected by the grating. Moreover, in one embodiment, the Bragg grating 180 are formed on the cladding portion of a waveguide 200 and the waveguide 190 is formed with a grating window 195 to allow the Bragg grating 180 to couple to the waveguide 190. The reflected signal from the grating 180 will propagate in the opposite direction along waveguide 200. Further, by shaping waveguide 200, the direction of the signal propagation may be controlled using conventional means.

The Bragg grating 180 merits further discussion. As noted above, it has been discovered that a Bragg grating 180 that is in sufficiently close proximity to an optical waveguide will cause a certain wavelength of light to be coupled out of the waveguide and reflected by the Bragg grating. The specific wavelength that will be reflected is dependent upon the periodicity of the Bragg grating.

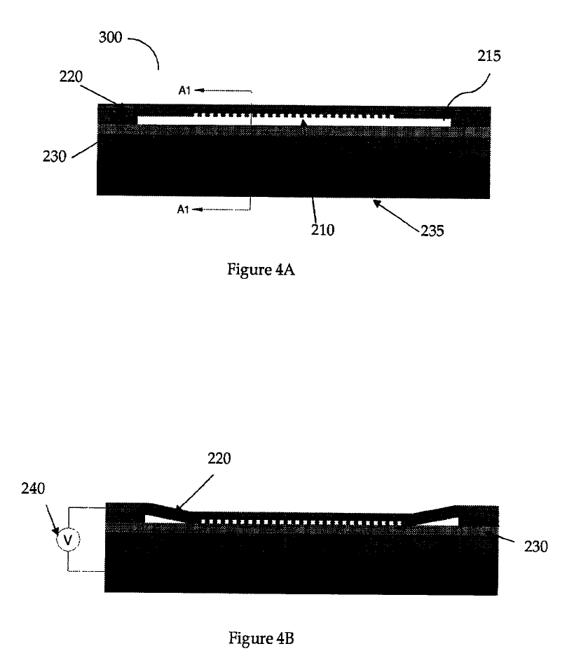

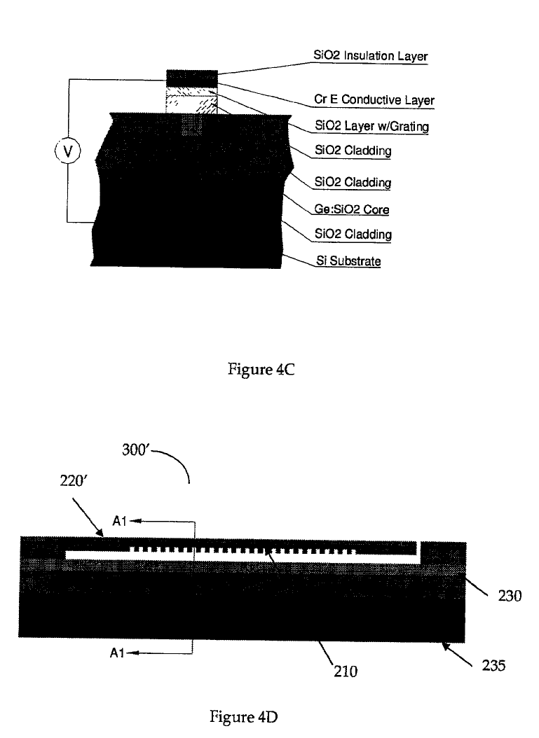

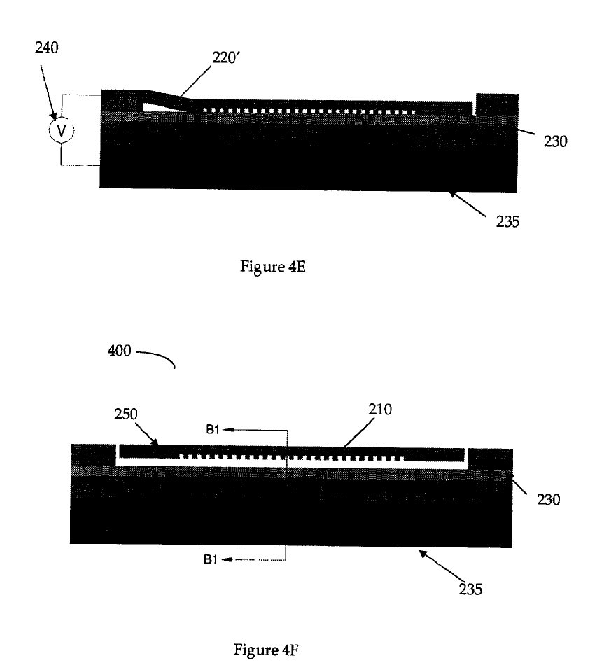

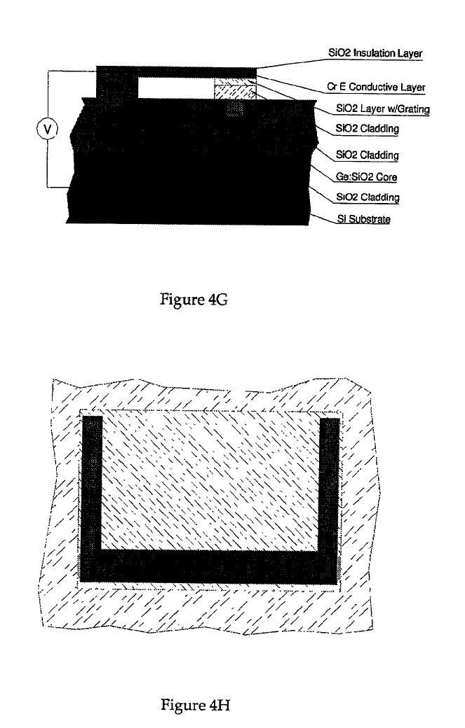

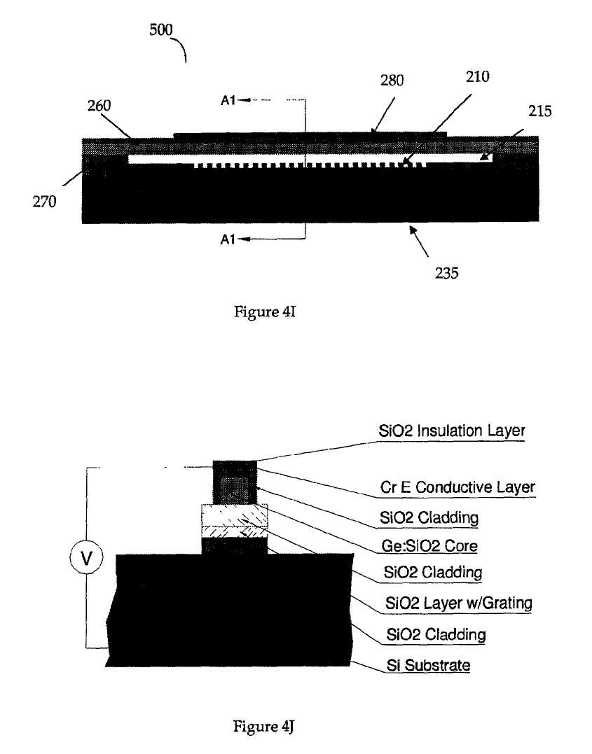

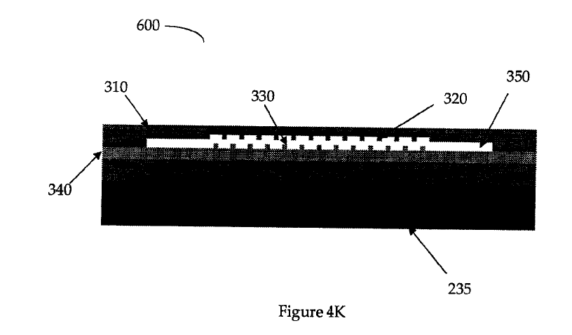

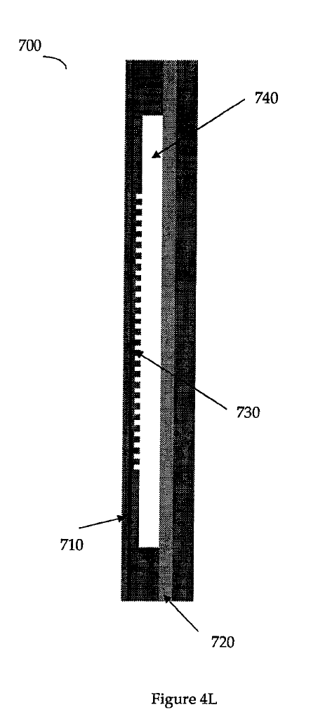

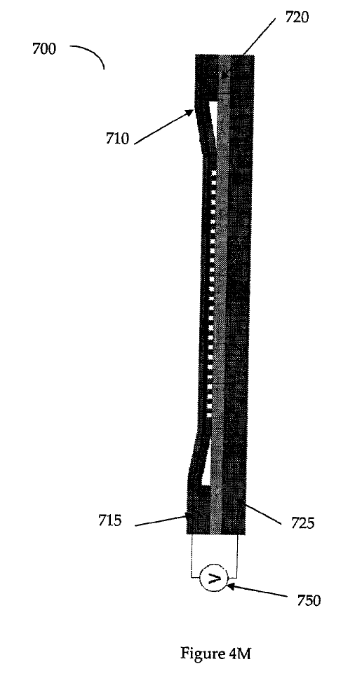

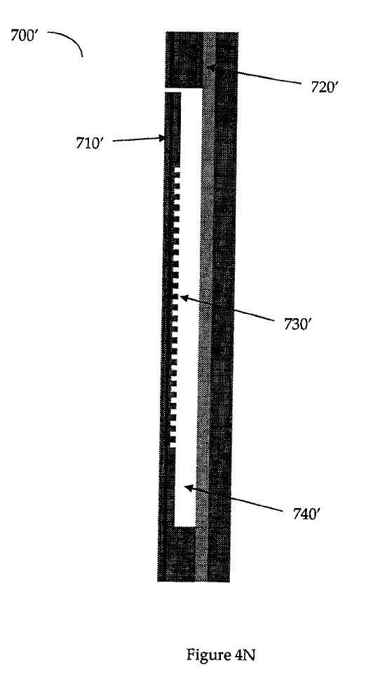

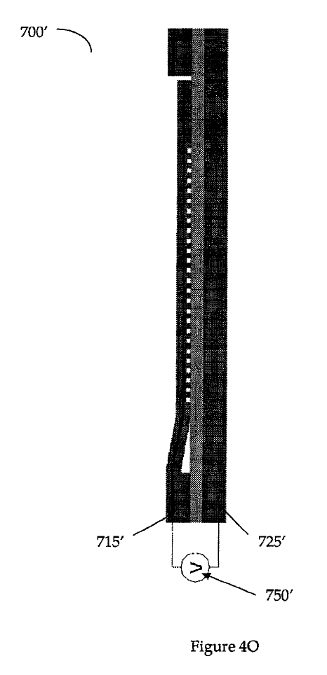

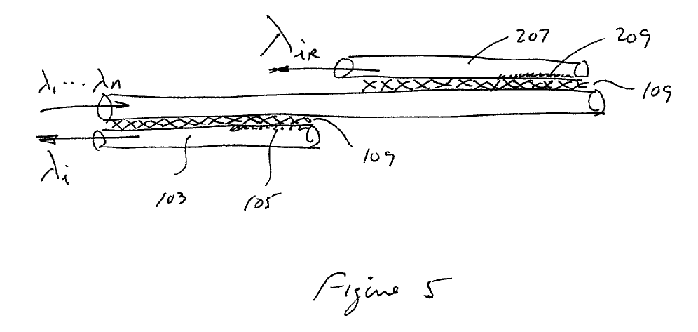

FIG. 4A shows a cross sectional view of an alternative embodiment of a switchable Bragg grating filter 300. The filter 300 includes a bridge beam 220, a Bragg grating formed on the bridge beam 220, a substrate 235, and a waveguide 230. The waveguide 230 carries an optical signal and is formed on the substrate using conventional techniques. The bridge beam 220 may also be formed to act as an optical waveguide to propagate an optical signal that is reflected by the Bragg grating 210. The optical signal may contain a single wavelength of light or a plurality of wavelengths of light (multiplexed). The bridge beam 220 is suspended above the waveguide 230 and is separated from the waveguide 230 by a gap 215. The Bragg grating 210 is formed on the underside of the bridge beam 220 so as to face the waveguide 230.

Thus, the Bragg grating 210 is formed on the bridge beam 220 and positioned with the bridge beam 220 and the Bragg grating 210 to be separated from the waveguide 230 by gap 215. When the filter 300 is in the “off” position shown in FIG. 4A, the Bragg grating 210 is not in proximity to the waveguide. This results in no coupling and reflection of the optical signal carried by the waveguide 230.

In FIG. 4B, the bridge beam 220 is deformed in a manner such that the gap 215 between the bridge beam 220 and the waveguide 230 is closed. The deformation may be effectuated by various means, such as by use of an electrostatic force. The deformation of the bridge beam 220 causes the Bragg grating 210 to couple to the waveguide 230. As discussed above, the coupling of the Bragg grating 210 to the waveguide 230 causes an optical signal of a specific wavelength to be reflected by the Bragg grating 210 and carried by the bridge beam 220 for redirection.

In one embodiment, by applying a DC voltage 240 between the substrate 235 and the bridge beam 220, the deformation of the bridge beam 220 may be accomplished by electrostatic forces. Further, the formation of bridge beam structures is well known in the art and any manner for MEMS switches would be equally suitable for the selectively coupling of the Bragg grating 210 to the waveguide 230.

FIG. 4C is a cross sectional view taken along line A1-A1 in FIG. 4A. Specifically, there is an electrically conductive layer formed within the bridge beam 220 for applying the voltage to assert an electrostatic force to bend the bridge beam 220. The electrostatic force thus activates the movable filter, thereby coupling waveguide 230 to another waveguide provided with (integral or non-integral) Bragg grating 210 to carry out a wavelength-selective optical filter function.

FIG. 4D is an alternate embodiment of the switchable Bragg grating filter 300′ with the bridge beam formed as a cantilevered beam 220′. In many respects, this embodiment is similar to the embodiment shown in FIGS. 4A-4C except that cantilevered beam is used. In FIG. 4E, the cantilevered beam 220′ is deformed electrostatically by a voltage source 240 to couple with the waveguide 230. The coupling of the Bragg grating 210 to the waveguide 230 activates the switchable filter 300′ for reflecting an optical signal specific to the Bragg grating 210. Thus, when activated, the Bragg grating 210 is useful for extracting an optical signal having a specific wavelength from the waveguide 230 and redirecting the optical signal into a waveguide associated with the cantilevered beam 220′.

FIG. 4F is an alternate embodiment of a switchable Bragg grating filter 400 with two cantilevered beams 250. FIG. 4G is a cross sectional view taken along line B1-B1 in FIG. 4F. FIG. 4H is a top view of the switchable grating optical filter 400.

FIG. 4I is an alternate embodiment of a switchable Bragg grating filter 500 with a bridge beam 260. In this embodiment, the Bragg grating 210 is formed on the substrate 235 and the optical waveguide 270 is formed integral with the bridge beam 260. FIG. 4J is a cross section view taken along line A1-A1 of FIG. 4I. Specifically, there is an electric conductive layer 280 formed on the bridge beam 260 for applying the voltage to assert an electrostatic force to bend the bridge beam 260. The electrostatic force thus activates the movable filter by coupling a waveguide 260 to another waveguide 270 provided with Bragg gratings 210 to carry out a wavelength-selective optical functions.

FIG. 4K is yet another alternative embodiment of a switchable Bragg grating filter 600 with a bridge beam 310. In this embodiment, both the substrate waveguide 340 has a Bragg grating 330 and the waveguide on the bridge beam 310 has a Bragg grating 320. The electrostatic force thus activate the movable filter by coupling a waveguide 310 provided with Bragg gratings 320 to another waveguide 340 provided with Bragg gratings 330 to carry out a wavelength-selective optical functions.

FIG. 4L and FIG. 4M show top views of another preferred embodiment of a switchable Bragg grating filter 700 of this invention. Instead of arranging the coupling between waveguides as several vertical layers supported on a semiconductor substrate as shown above, the coupling waveguides 710 and 720 are formed on a same layer supported on a semiconductor substrate. Two coupling and movable waveguides 710 and 720 with electrode layers 715 and 725 and gap 740 allow for Bragg gratings 730 to be formed on a top surface of the substrate on a same planar layer. Again, the Bragg gratings 730 can be formed on one or both of the waveguides 710 and 720 as described above. The electrostatic voltage 750 is applied to move the coupling waveguide near each other to activate an optical filter according to a same operational principle as described above.

FIG. 4N and FIG. 4O show top views of another preferred embodiment of a switchable Bragg grating filter 700′ of this invention. Instead of arranging the coupling between waveguides as several vertical layers supported on a semiconductor substrate as shown above, the coupling waveguides 710′ and 720′ are formed on a same layer supported on a semiconductor substrate. Two coupling and movable waveguides 710′ and 720′ with electrode layers 715′ and 725′ and gap 740′ allow for Bragg gratings 730′ to be formed on a top surface of the substrate on a same planar layer. Again, the Bragg gratings 730′ can be formed on one or both of the waveguides 710′ and 720′ as described above. The electrostatic voltage 750′ is applied to move the coupling waveguide near each other to activate an optical filter according to a same operational principle as described above.

The description above relates to the use of MEMS technology to selectively move a Bragg filter towards an input waveguide. While this may be preferred for certain applications, other means for switching the Bragg filter to the input waveguide are equally effective. For example, liquid crystal switching may also be used. In particular, the technology disclosed in U.S. Pat. No. 6,266,109 may be used to switch the filter on and off As seen in FIG. 5, the output waveguide 103 and the input waveguide 101 are formed adjacent to each other. The input 101 and output 103 waveguides are separated by a thin layer of liquid crystal material 109 that is electrically controlled to become either isotropic or anisotropic. By electrically controlling the liquid crystal material, the wavelength λᵢ can be allowed to pass through to the Bragg filter (on position) or be blocked from the Bragg filter (off position). Another way of applying liquid crystal technology to a Bragg grating based filter is to have the grating be made of a liquid crystal material. In such a manner, the ON/OFF function of the filter is controlled by altering its periodic structure by the application of an electrical field. For example, a holographic polymer dispensed liquid crystal exhibiting an electro-optics effect is created to have periodic structures that can be created by spatially distributing liquid crystal nanodroplets in a constrained polymer matrix. This embodiment avoids the need for movable waveguides and MEMS structures.

While the invention is described and illustrated here in the context of a limited number of embodiments, the invention may be embodied in many forms without departing from the spirit of the essential characteristics of the invention. The illustrated and described embodiments are therefore to be considered in all respects as illustrative and not restrictive. Thus, the scope of the invention is indicated by the appended claims rather than by the foregoing description, and all changes which come within the meaning and range of equivalency of the claims are intended to be embraced therein.

What is claimed is:

1. A wavelength-selective optical filter comprising:
an input waveguide for carrying a multiplexed optical signal that includes a plurality of wavelength channels;
an output waveguide adjacent to said input waveguide, said output waveguide having a Bragg grating filter formed thereon, said input waveguide and said output waveguide separated by a gap distance when said filter is in an off state; and
means for displacing said Bragg grating filter sufficiently towards said input waveguide when said filter is in an on state such that said Bragg grating filter can selectively extract one of said plurality of wavelength channels.

2. The wavelength-selective optical filter of claim 1 wherein said Bragg grating filter has a periodicity suitable for filtering said one of said plurality of wavelength channels into said output waveguide.

3. The wavelength-selective optical filter of claim 1 wherein said means for displacing comprises an electrically controllable microelectromechanical system (MEMS).

4. The wavelength-selective optical filter of claim 1 further comprising:
a residual filter adjacent to said input waveguide, said residual filter having a second Bragg grating filter formed thereon, said input waveguide and said residual filter separated by a gap distance when said residual filter is in an off state; and
second means for displacing said second Bragg filter sufficiently towards said input waveguide when said residual filter is in an on state such that said second Bragg grating filter can selectively extract any residual portion of said one of said plurality of wavelength channels.

5. The wavelength-selective optical filter of claim 1 wherein said means for displacing is an electrostatic moving means for moving said Bragg grating filter for activating said Bragg grating filter.

6. A method of filtering a selected one of a plurality of wavelengths of a multiplexed optical signal carried by an input waveguide to an output waveguide, the method comprising:
placing said output waveguide adjacent to said input waveguide, said output waveguide having a Bragg grating filter formed thereon, said input waveguide and said output waveguide separated by a gap distance when said filter is in an off state; and
displacing said Bragg grating filter sufficiently towards said input waveguide when said filter is in an on state such that said Bragg grating filter can selectively extract said selected one of said plurality of wavelength channels.

7. The method of claim 6 wherein said Bragg grating filter has a periodicity suitable for filtering said one of said plurality of wavelength channels into said output waveguide.

8. The method of claim 7 wherein said displacing is performed by an electrically controllable microelectromechanical system (MEMS).

9. The method claim 6 further comprising:
placing a residual filter adjacent to said input waveguide, said residual filter having a second Bragg grating filter formed thereon, said input waveguide and said residual filter separated by a gap distance when said residual filter is in an off state; and
displacing said second Bragg grating filter sufficiently towards said input waveguide when said residual filter is in an on state such that said second Bragg grating filter can selectively extract any residual portion of said one of said plurality of wavelength channels.

10. The method of claim 6 wherein displacing is performed by an electrostatic moving means for moving said Bragg grating filter for activating said Bragg grating filter.

11. A wavelength-selective optical filter comprising:
an input waveguide for carrying a multiplexed optical signal that includes a plurality of wavelength channels;
an output waveguide adjacent to said input waveguide, said output waveguide having a Bragg grating filter formed thereon, said input waveguide and said output waveguide separated by a gap distance when said filter is in an off state; and
a liquid crystal material formed between said input waveguide and Bragg grating filter of said output waveguide, said liquid crystal material capable of changing from an isotropic to an anisotropic material.

12. The wavelength-selective optical filter of claim 11 wherein said Bragg grating filter has a periodicity suitable for filtering said one of said plurality of wavelength channels into said output waveguide.

13. The wavelength-selective optical filter of claim 11 wherein said liquid crystal material is controllable by an electrical signal.

14. The wavelength-selective optical filter of claim 11 further comprising:
a residual filter adjacent to said input waveguide, said residual filter having a second Bragg filter formed thereon, said input waveguide and said residual filter separated by a gap distance; and
a second liquid crystal material formed between said input waveguide and Bragg filter of said residual filter, said liquid crystal material capable of changing from an isotropic to an anisotropic material.

15. A method of filtering a selected one of a plurality of wavelengths of a multiplexed optical signal carried by an input waveguide to an output waveguide, the method comprising:
placing said output waveguide adjacent to said input waveguide, said output waveguide having a Bragg grating filter formed thereon, said input waveguide and said output waveguide separated by a gap distance that is occupied by a liquid crystal material; and
applying an electrical signal to said liquid crystal material so that said input waveguide is coupled to said Bragg grating filter such that said Bragg grating filter can selectively extract said selected one of said plurality of wavelength channels.

16. The method of claim 15 wherein said Bragg grating filter has a periodicity suitable for filtering said one of said plurality of wavelength channels into said output waveguide.

17. The method claim 6 further comprising:
placing a residual filter adjacent to said input waveguide, said residual filter having a second Bragg grating filter formed thereon, said input waveguide and said residual filter separated by a gap distance that is occupied by a second liquid crystal material; and
applying an electrical signal to said second liquid crystal material so that said input waveguide is coupled to said second Bragg grating filter such that said second Bragg grating filter can selectively extract said selected one of said plurality of wavelength channels.
